(19) United States
(12) Patent Application Publication
(10) Pub. No.: US 2021/0235629 A1
(43) Pub. Date: Aug. 5, 2021

(54) Planter

(71) Applicant: KnowingNature LLC, New York, NY (US)

(72) Inventor: Rachel Haber, New York, NY (US)

(21) Appl. No.: 17/169,314

(22) Filed: Feb. 5, 2021

Related U.S. Application Data
(60) Provisional application No. 62/970,489, filed on Feb. 5, 2020.

(51) Int. Cl. A01G 9/02; A01G 9/04

(52) U.S. Cl. CPC A01G 9/02; A01G 9/04

(57) ABSTRACT

In one or more implementations, an improved planter and associated base are provided. In one particular implementation, a planter portion is configured to receive a planting medium and one or more plants for implantation into the planting medium, the planter portion having a base, two opposing first sidewalls having a first length and two opposing second sidewalls having a second length, wherein the first and second side walls are joined to the base portion; the base portion and the first side walls having a plurality of passages therethrough, a rim connected to the first and second side walls by a shoulder; and a receiver portion configured to receive the planter portion, the receiver portion having a bottom portion configured with at least one depression disposed therein, a first opposing pair of receiver side walls and a second opposing pair of receiver side walls, the first and second receiver pairs each joined to the bottom portion, a receiver rim connected to the first and second receiver pairs, wherein the first receiver side walls have substantially the same length as the first opposing side walls of the planter portion and the second receiver sidewalls have a length that is greater than the second side walls of the planter portion; wherein upon receiving the planter portion in the receiver portion, the rim of the planter portion lays substantially atop the rim of the base portion and the base of the planter portion lays substantially atop the base of the receiver portion.

### CROSS REFERENCE TO RELATED APPLICATION

The present application claims the benefit of U.S. patent application Ser. No. 62/970,489, filed Feb. 5, 2020, which is hereby incorporated by reference in its entirety.

### FIELD OF THE INVENTION

The present invention is directed to an improved planter apparatus. Specifically, in one or more implementations, the present invention is directed to a planter apparatus having an insert and a receiver, that when combined, improves water retention, promotes even germination, and resists the development of mold and rot.

### BACKGROUND OF THE INVENTION

Vessels for growing plants, such as planting pots, can come in a variety of designs and configurations. Such pots are frequently used to plant flowers, vines, small shrubbery, and other types of plants for either indoor or outdoor use. Typically, planting pots are formed from a wide variety of materials, such as ceramics, stone, metal, and various forms of lightweight, plastic that are suitable for permanent or temporary use by professional, amateur and hobbyist planters and gardeners. Often, for example as shown in U.S. patent application Ser. No. 7,043,877B1, herein incorporated by reference, these types of planting pots include small holes or apertures located on the bottom of the planter. These holes allow water to drain from the soil that has been placed into the pot.

It is known in the art that insufficient drainage or overwatering of pots contributes substantially to the formation of water spores or other fungi in soil or plants. In part, this is due to poor drainage, which leads to soil compaction at the bottom of the pot. Furthermore, some drainage holes in the sidewalls of typical pots are situated so that the light (artificial or natural) strikes the growing medium through the holes, thereby leading to a further possible source of fungus infection.

Thus, what is needed in the art is an approach that leverages the specific volumes and orientations of the planter and the medium so as to provide a stable, well aerated, and evenly watered environment for growing plants. For example, what is needed is a planter configuration that provides a plurality of drainage and aeration features and encourages roots of individual plants to grow horizontally and provide an optimal amount of soil volume to retain enough water for intermittent watering of plant varieties. Furthermore, what is needed is a configuration of a planter that allows for planter to be transported by persons with varying degrees of grip strength and fine motor control.

### SUMMARY OF THE INVENTION

In one or more implementations, an improved planter and associated base are provided. In one particular implementation, a planter portion is configured to receive a planting medium and one or more plants for implantation into the planting medium, the planter portion having a base, two opposing first sidewalls having a first length and two opposing second sidewalls having a second length, wherein the first and second side walls are joined to the base portion; the base portion and the first side walls having a plurality of passages therethrough, a rim connected to the first and second side walls by a shoulder; and a receiver portion configured to receive the planter portion, the receiver portion having a bottom portion configured with at least one depression disposed therein, a first opposing pair of receiver side walls and a second opposing pair of receiver side walls, the first and second receiver pairs each joined to the bottom portion, a receiver rim connected to the first and second receiver pairs, wherein the first receiver side walls have substantially the same length as the first opposing side walls of the planter portion and the second receiver sidewalls have a length that is greater than the second side walls of the planter portion; wherein upon receiving the planter portion in the receiver portion, the rim of the planter portion lays substantially atop the rim of the base portion and the base of the planter portion lays substantially atop the base of the receiver portion.

In one or more implementations, the improved planter described herein is configured to provide a stable planter on both even & uneven surfaces. For instance, the H-shaped depressions along the bottom of the receiver enhance the overall stability of the planter. Likewise, the improved planter allows for easy utilization by individuals having different hand strength, size and dexterity. For instance, the weight of the improved planter is distributed evenly (due to rims of the insert and receiver sitting atop one another) and the configuration provided herein takes advantage of a low center of gravity to enable easier usage.

In one or more implementations, the improved planter provides improved watering functionality. Specifically, the planting medium provided within the improved planter absorbs the correct amount of water through “Bottom Watering”. Here, the size, location and orientation of the drainage holes allows the entire soil medium to effectively absorb water that is poured into the receiver and for excess water to be discarded from the receiver. This is as opposed to water being poured onto the soil medium from above which could disturb the seeds, disturb the soil medium, wet the plants and/or result in over or under watering.

Furthermore, the improved planter described herein allow for water to be distributed and absorbed evenly throughout the soil because of the gap and depression introduced therein. These features allow water to reach all the drainage holes, which leads to multiple seeds in the planter receiving (1) the correct amount of water (2) at the same time so that germination of the seeds happen evenly. For example, the drainage holes allow excess water to exit the planting medium, and the depressions in the receiver capture excess water and prevents it from coming into contact with the planting medium.

The described improved planter also is configured to increase soil & root aeration. For example, when there is no water in the gap between the planter and the receiver or in the depression of the receiver, air flows through these features and reaches the drainage holes and provides more oxygen to the soil and roots. Such improved air flow results in healthier plants and better plant growth. Additionally, the improved planter provided herein allows for reduced mold and fungus growth along the walls of the planter and in the soil and roots. When there is no water in gap and depression, air flows 360-degrees around the planter and within receiver, thus drying the planter walls and depriving mold and fungus of the moisture that causes it to thrive in the crevices of planters and soil.

### BRIEF DESCRIPTION OF THE DRAWINGS

FIG. 1 is a perspective, exploded view detailing particular elements of the described improved planter;

FIG. 2 is a perspective view detailing particular elements of the described improved planter;

FIG. 3 is a side view detailing particular elements of the described improved planter;

FIG. 4 is a side view detailing particular elements of the described improved planter;

FIG. 5 is a front view detailing particular elements of the described improved planter;

FIG. 6 is a front view detailing additional particular elements of the described improved planter;

FIG. 7 is a top view detailing additional particular elements of the described improved planter of FIG. 6;

FIG. 8 is a bottom view detailing particular elements of the described improved planter of FIG. 6;

FIG. 9 is a bottom view detailing additional particular elements of the described improved planter;

FIG. 10 is a side view detailing particular elements of an embodiment of the described improved planter;

FIG. 11 is a top view detailing particular elements of an embodiment of the described improved planter of FIG. 10;

FIG. 12 is a top view detailing particular elements of an embodiment of the described improved planter;

FIG. 13 is a bottom view detailing particular elements of an embodiment of the described improved planter;

FIG. 14 is a bottom view detailing further particular elements of an embodiment of the described improved planter;

FIG. 15 is a perspective view detailing particular elements of an embodiment of the described improved planter;

FIG. 16 is a cross-sectional detailing particular elements of an embodiment of the described improved planter;

FIG. 17 is a cross-sectional view detailing particular elements of an embodiment of the described improved planter;

FIG. 18 is a side view detailing particular elements of an embodiment of the described improved planter where the planter insert is provided in the receiver;

FIG. 19 is a perspective view detailing particular elements of an embodiment of the described improved planter where the planter insert is provided in the receiver; and

FIG. 20 is a perspective view of an embodiment of the described improved planter where the planter insert is provided in the receiver.

### DETAILED DESCRIPTION OF CERTAIN EMBODIMENTS OF THE INVENTION

By way of overview and introduction, the present disclosure relates to an improved planter apparatus that provides a plurality of drainage, aeration and watering options and encourages roots of individual plants to grow horizontally and provide an optimal amount of soil volume to retain enough water for intermittent watering of plant varieties.

Various implementations and embodiments of the foregoing can be described or explained with reference to the accompanying figures in which like reference numbers refer to like elements throughout. By way of introduction, the term “planter” as used herein refers to any vessel, formed of any materials, that is used to hold one or more plants of any variety or one or more seeds of a plant, whether germinating or not. For example, the term planter as used herein applies to a vessel retaining soil and incorporating one or more germinated seeds and or mature plants of any variety. While the foregoing examples and explanations provide the example of planter provided herein, those possessing an ordinary level of skill in the requisite art will understand and appreciate that different configurations may be captured under the broad definition of the term “planter.”

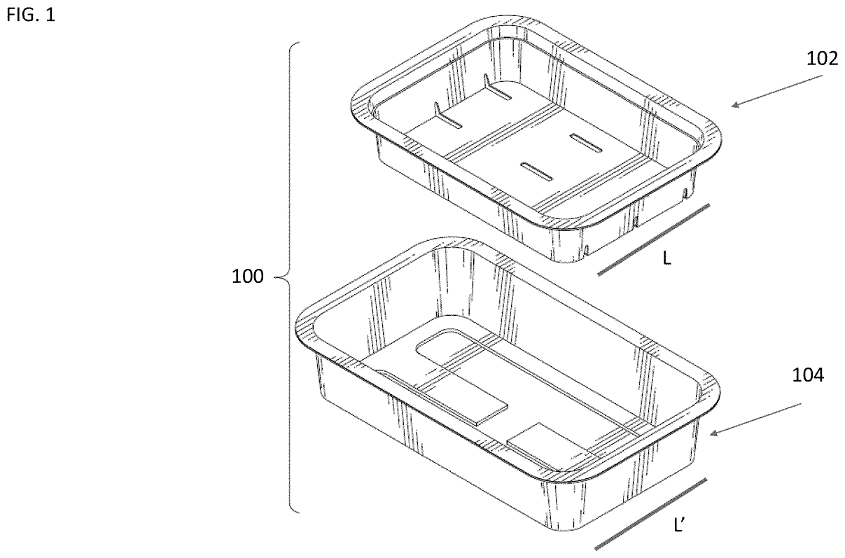

With reference to the following figures, a multi part planter is provided as shown in FIG. 1. In one implementation, the multi-part planter 100 includes a planter insert 102. The planter insert 102 is configured to be inserted into a receiver 104. As shown, in one or more implementations, the dimensions of the planter insert 102 are such that the planter insert 102 is able to be inserted into the receiver 104 when both the insert 102 and receiver 104 are aligned along a common axis. For example, both the planter insert 102 and the receiver 104 have similar widths, such that the planter insert 102 can be placed within the receiver 104. As illustrated, the width of the planter insert 102 (shown as L) is smaller than the width of the planter base L′. However, in one or more implementations, the width of the planter base L′ is substantially similar to the length L such that upon insertion of the insert 102 into the receiver 104 only a small gap is present between the sidewalls of the respective insert 102 and receiver 104.

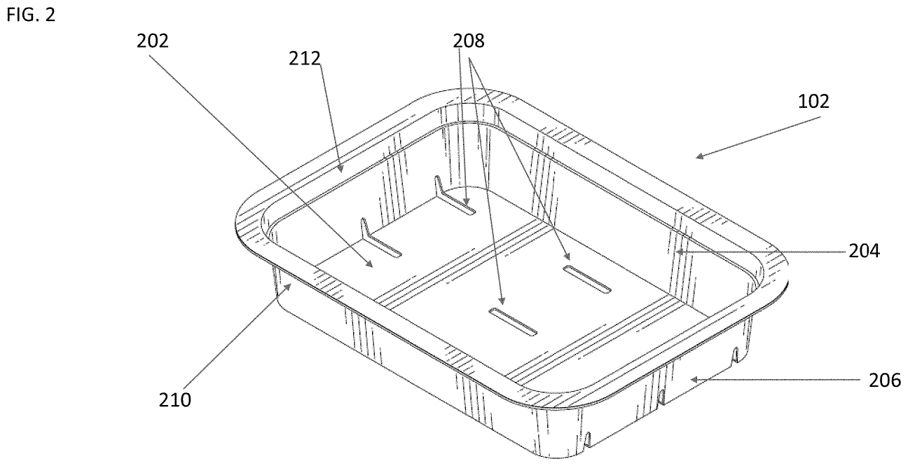

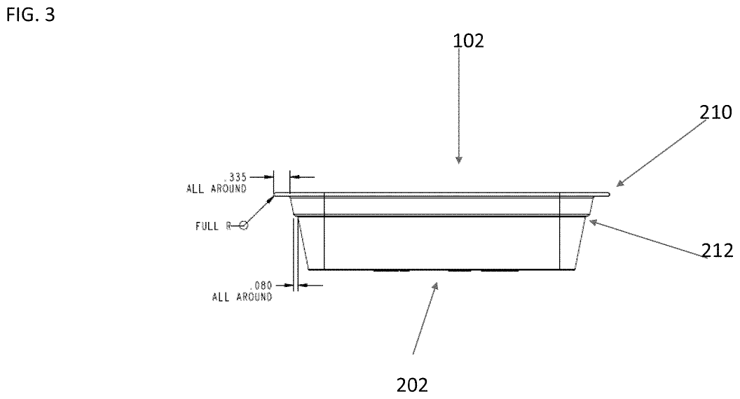

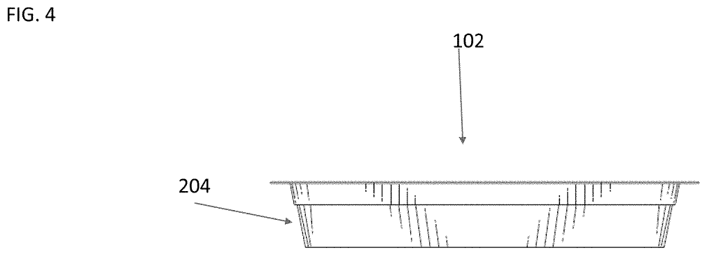

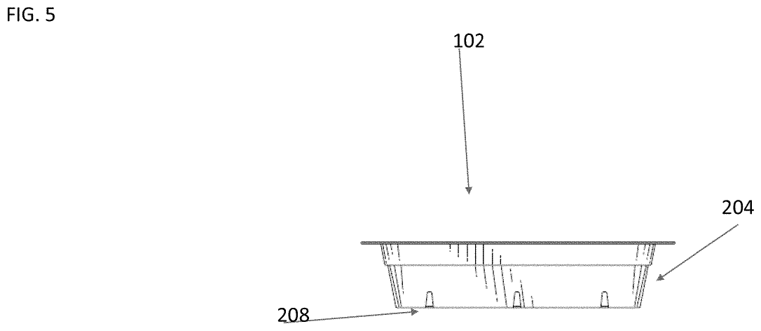

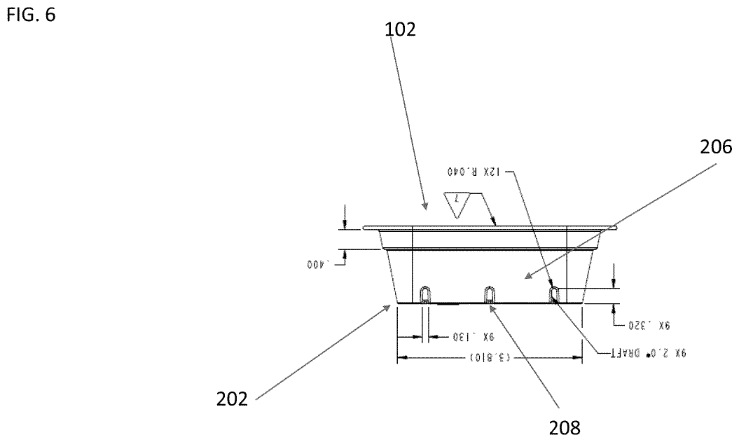

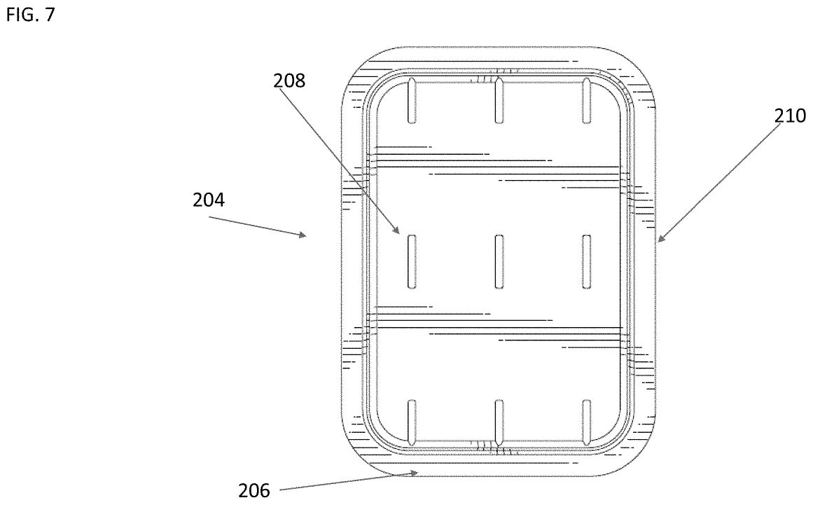

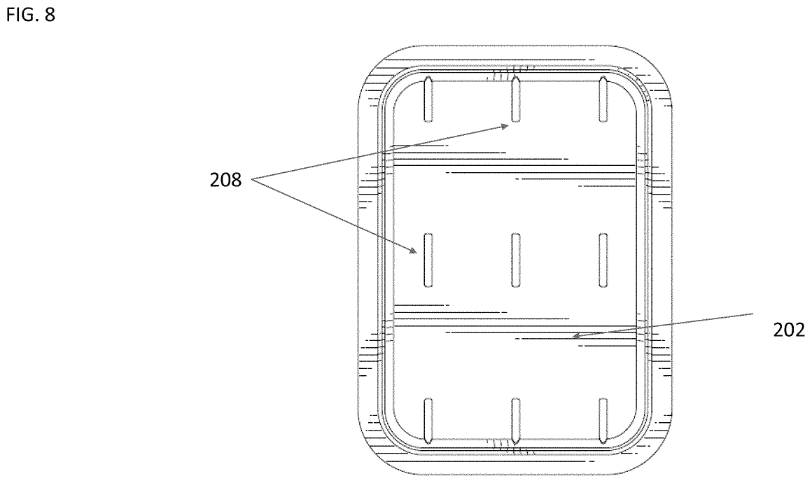

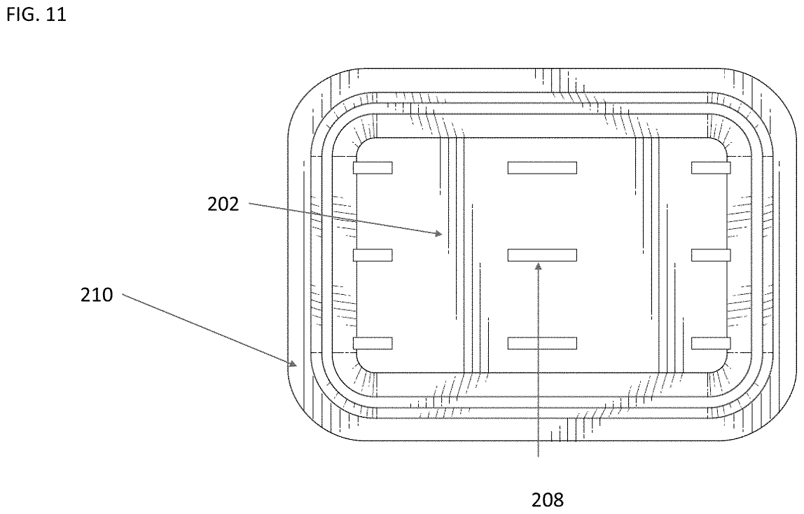

In one or more implementations, as shown in FIGS. 2-11, an improved planter insert 102 is configured with a base 202, two opposing first sidewalls having a first length 204 and two opposing second sidewalls having a second length 206. As shown in FIG. 2, the first and second side walls are joined to the base 202. In one or more implementations, the side walls are joined to the base 202 at a 90-degree angle. In an alternative configuration, the side walls are joined to the base 202 at a less than 90-degree angle. In still a further alternative configuration, the side walls are joined to the base 202 at a greater than 90-degree angle.

As further shown, the planter inset 102 also includes a rim 210 connected to the first and second side walls by a shoulder 212.

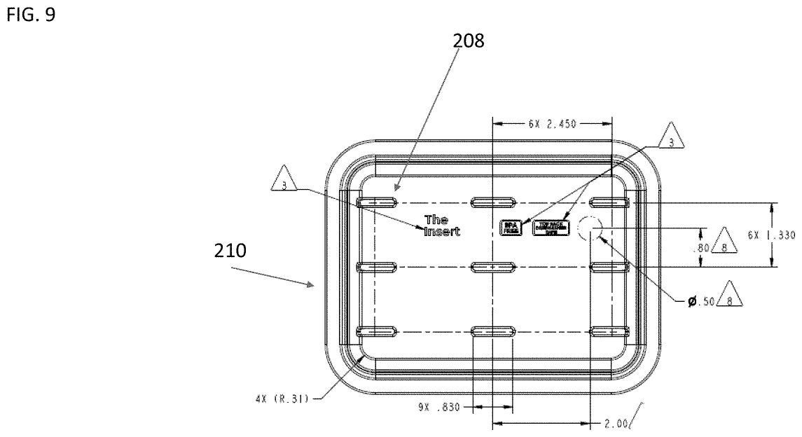

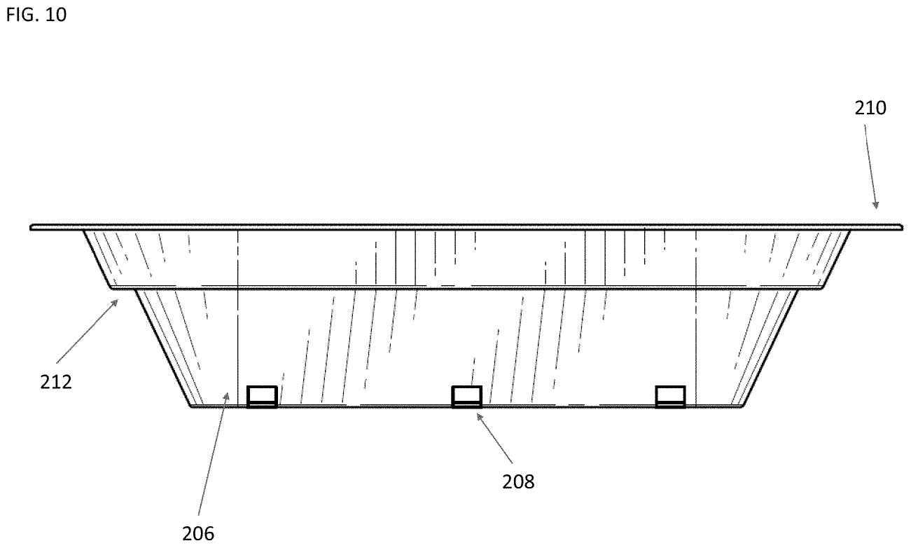

As further shown in FIGS. 2-9, in one or more implementations the base 202 and the first side walls 206 have a plurality of passages or drainage holes 208 disposed therein. In one or more implementations, the drainage holes 208 are equally distributed throughout the base 202. In a further implementation, the drainage holes 208 each have the same dimensions. In an alternative implementation, a first group of drainage holes 208 have different dimensions than a second group of drainage holes. For instance, as shown in FIGS. 2 and 5-8, the drainage holes in the center of the base 202 have a flat configuration, while drainage holes on the edge of the base 202 have a flat portion and an angled portion that extends into the side walls 206. In one particular implementation, the configuration of the drainage holes 208 that extend to the side walls have a tapered portion extending in the direction of the rim 210. In one particular implementation, the configuration of the drainage holes 208 that extend to the side walls have a rounded portion extending in the direction of the rim 210. In one or more implementations, shown in FIGS. 9-10, the drainage holes 208 have a squared-off configuration extending in the direction of the rim 210.

In one or more implementations, the planter insert 102 is formed of any material suitable for the purposes of receiving a planting medium. For example, the planter insert 102 is formed of any natural, synthetic or composite material suitable for such purposes. For example, the planting medium is soil, growing medium or any substance suitable for growing or maintaining the health of plants.

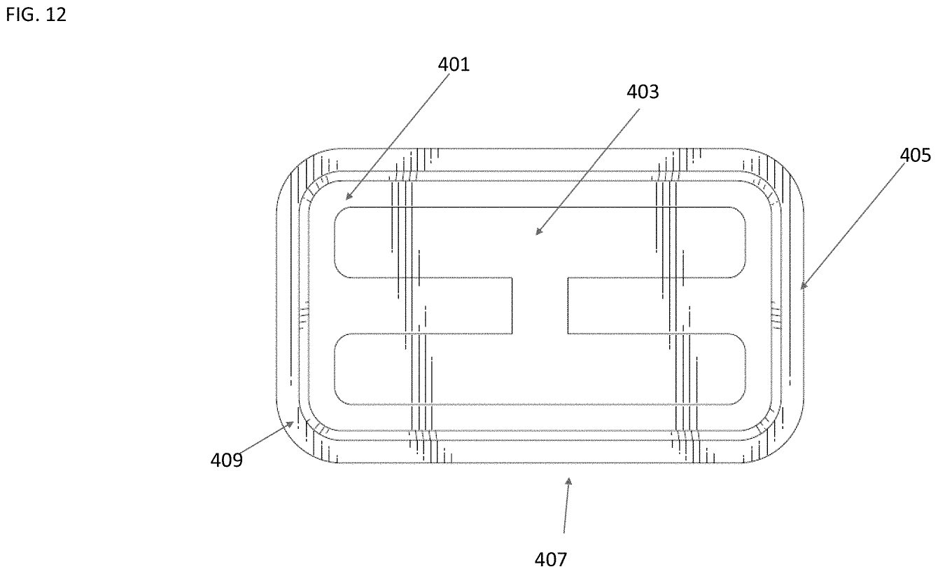

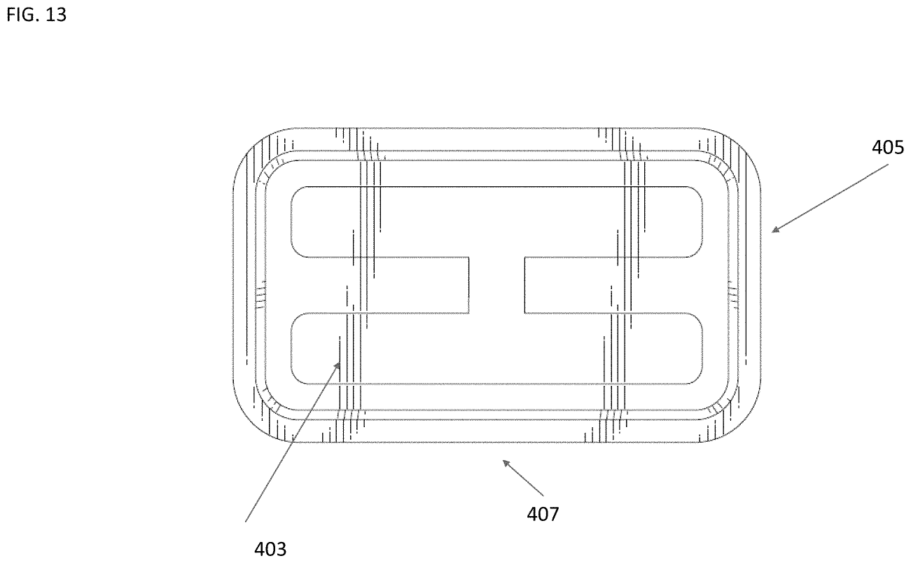

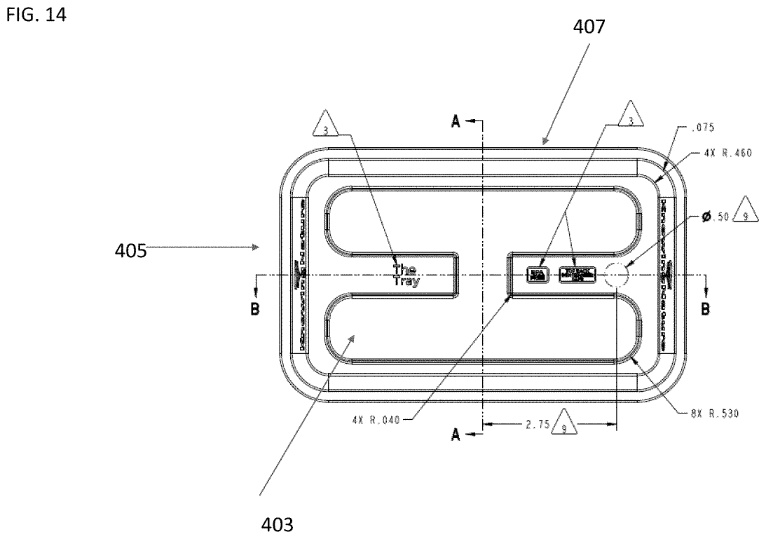

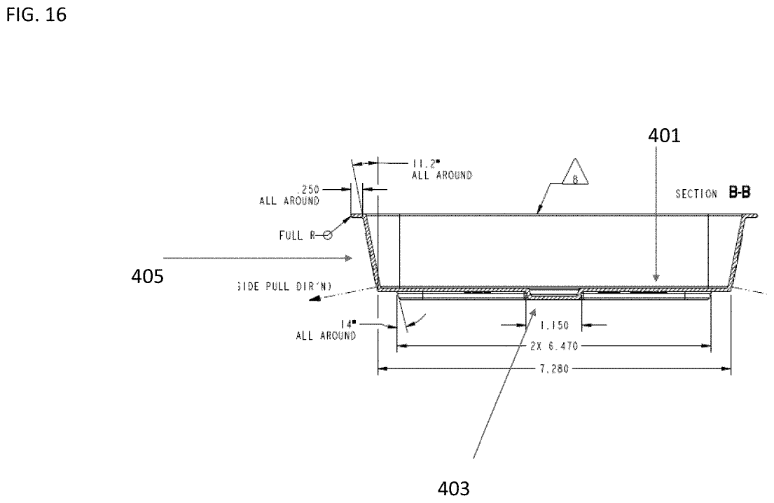

As shown in more detail in FIGS. 12-18, the receiver portion 104 is configured to receive the planter insert 102. In one or more configurations, the receiver portion 104 has a bottom portion 401 configured with at least one depression 403 disposed therein. In a particular implementation, the at least one depression 403 constitutes a substantial portion of the bottom portion 401 The receiver portion includes a first opposing pair of receiver side walls 405. In a further implementation, the at least one depression 403 is implemented in a “H” shaped depression.

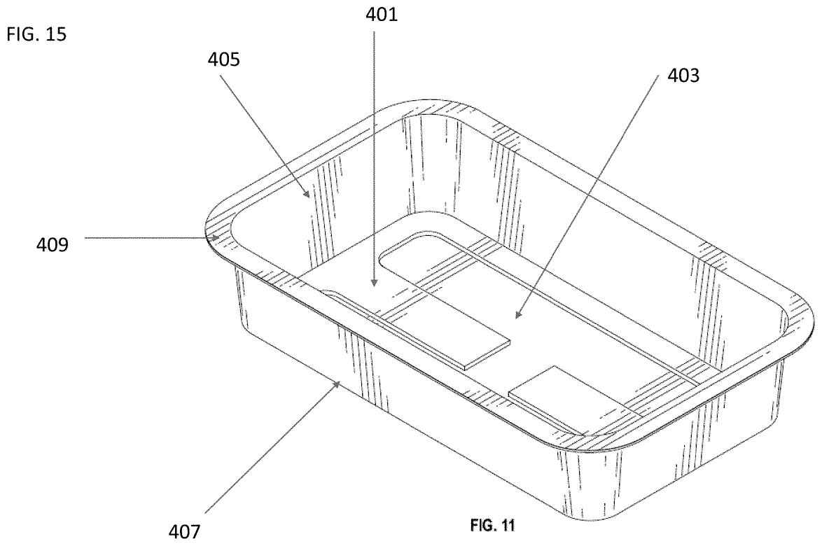

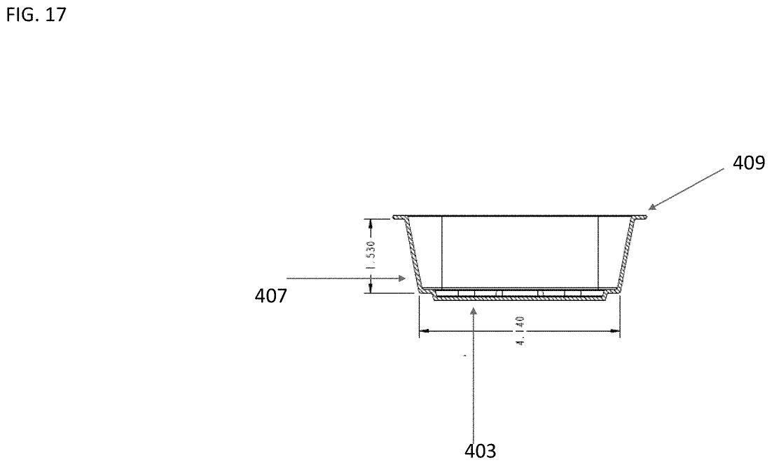

The receiver portion 104 further includes a second opposing pair of receiver side walls 407. In one or more configurations, the length of the first pair of sidewalls 405 has a different length than the second opposing pair of sidewalls 407. As shown in FIG. 15, both the first and second receiver pairs are each joined to the bottom portion 401. As further shown in FIGS. 15 and 17, the receiver portion 104 includes a rim 409 connected to the first and second receiver pair sidewalls (405, 407).

In one or more configurations, the receiver 104 is formed of any material suitable for the purposes of receiving a planting insert 102. For example, the receiver 104 is formed of any natural, synthetic or composite material suitable for such purposes. In one particular implementation, both the receiver 104 and the planter insert 102 are formed of the same material. In an alternative configuration, the receiver 104 and the planter insert 102 are formed of different materials.

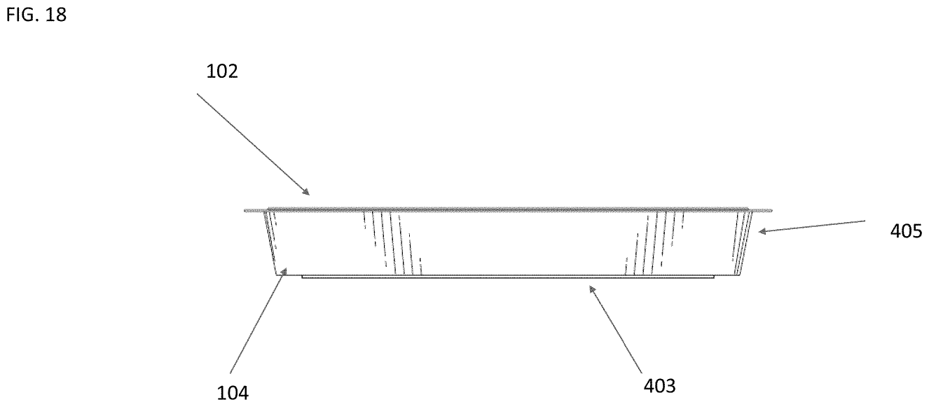

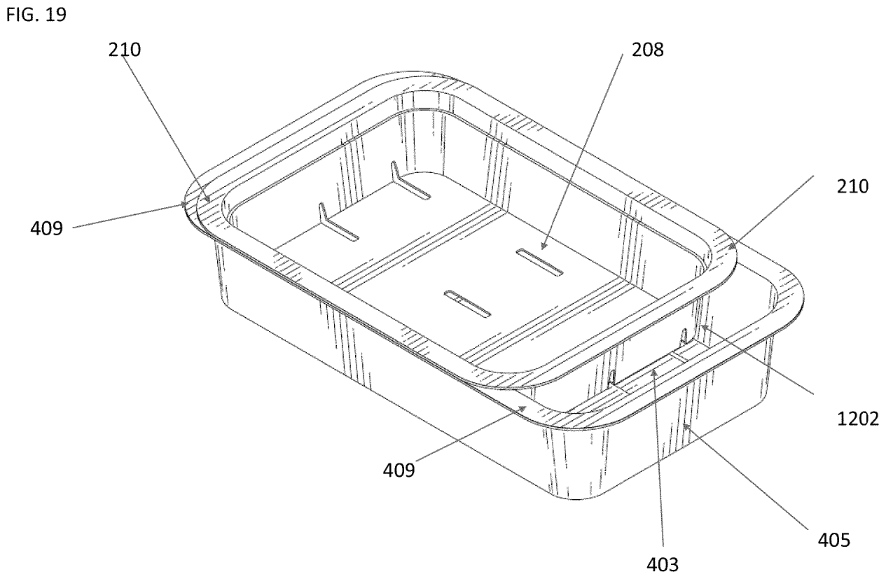

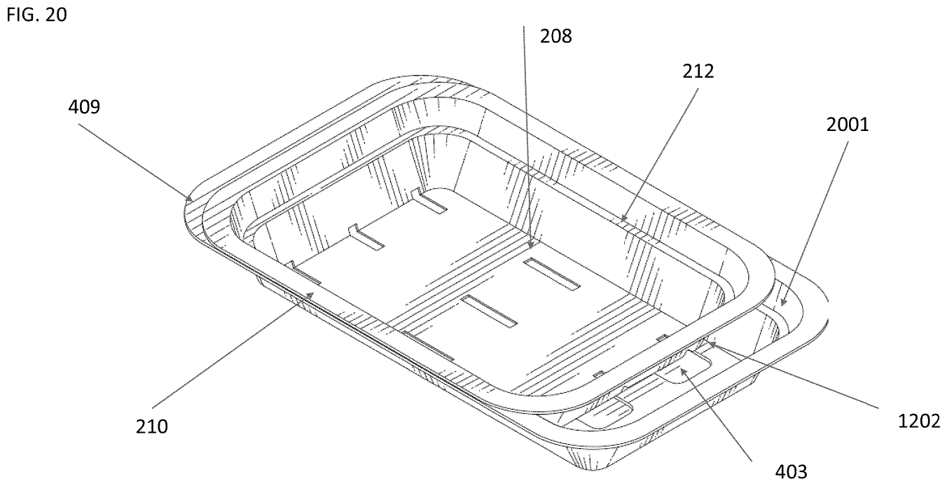

As shown in FIGS. 18-20, the receiver 104 is configured to receive the planter insert 102. In one arrangement, the first receiver side walls of the receiver portion 104 have substantially the same length as the first opposing side walls of the planter portion 102. Furthermore, the second receiver sidewalls of the receiver portion 104 have a length that is greater than the second side walls of the planter portion 102. For example, as shown in FIGS. 19-20, upon receiving the planter portion 102 in the receiver portion 104, the rim of the planter portion 210 lays substantially atop the rim of the receiver portion 409.

It shall be appreciated that the “H-base” depression 403 of the receiver 104 allows the planter insert 102 to rest above excess water in the receiver 104 when such water is present. Furthermore, the depth, placement and slope of “H” recess 403 along the base of the receiver 104 on which the planter insert 102 rests allows the combined planter 100 to be placed on flat as well as slightly uneven or stepped surfaces and discourages the planter insert 102 from rocking, tipping or falling over.

In one or more implementations, the surface area-to-depth ratio of the side walls relative to the base 202 of the planter insert 102 is configured to provide an improved planting configuration. For example, the surface area-to-depth ratio of the planter insert 102 encourages roots of individual plants to grow horizontally and provides an optimal amount of soil volume for microgreens. In one non-limiting example, such a configuration supports the upright growth and retention of enough water for microgreens secured within a planting medium provided in the planter insert 102 to be watered only once a day (as compared to other methods of microgreen growing that require watering several times a day).

In a further implementation, the size & placement of drainage holes 208 and recesses of the planter insert 102 is configured to improve the planter characteristics relative to the prior art. For example, the drainage holes 208 and the recesses in the receiver 104 are configured to encourage optimal watering of plants through “bottom-watering” AND 360 degrees air flow. For example, as shown in FIG. 19, the gap 1202 present between the side walls of the insert 102 and the receiver portion 104 allows for air to reach all parts of the planter insert 102 and receiver 104.

In an alternative configuration shown in FIG. 20, the gap 1202 is more pronounced with the presence of a shoulder 2001 in the sidewalls of the receiver 104. In an alternative configuration, shown in FIG. 19, the gap 403 present between the base 202 of the insert 102 and the depression 403 of the receiver portion 104 allows for air to reach the drainage holes 208 of the insert 102.

Regardless of the configuration, the gap 1202 and depression 403 allows for air to reach the outer walls of the insert 102, the inner walls of the receiver portion 104 and the drainage holes 208 of the insert 102, thereby preventing mold growth and providing additional oxygen to plant roots (each of which increases the health of plants).

Likewise, such a configuration allows for the water to flow evenly to all the drainage holes such that the soil will be evenly watered which promotes even germination. In one or more further implementations, the configuration of the improved planter allows for water to be distributed and absorbed evenly throughout the soil. For instance, the gap between the planter and the receiver and depression of the improved planter allows the water to reach all the drainage holes. As such, multiple seeds in the planter receive (1) the correct amount of water (2) at the same time so that germination of the seeds occurs evenly.

Additionally, such configurations are adapted to ensure that when the planter does not contain water, air penetrates the drainage holes and depressions which (i) prevents mold/fungus along the walls of the planter AND in the soil, and (ii) aerates the roots/soil for healthier plants. Furthermore, the configurations described herein provide for recesses along the bottom of the receiver that captures excess water that drains from the soil.

In a particular implementation, when the planter insert 102 is placed inside the receiver 104, for example, as shown in FIGS. 19-20, the volume of space within the receiver 104 that is not occupied by the planter insert 102 can hold the amount of water that is necessary to “bottom-water” the amount of soil that is in the planter insert 102. When the planter insert 102 is not being watered, that same empty space 1201 within the receiver 104 allows for air to continually flow and not stagnate inside the receiver 104.

In yet a further feature of the planter provided herein, the overall dimensions and relative dimensions of the various elements of both the planter insert 102 and the receiver 104 are configured to maintain an overall low center of gravity. Furthermore, in one or more configurations, the rims 210 of the planter insert 102 sit evenly along the rims 409 of the receiver 104 such that pressure applied in one area of the planter insert 102 is distributed throughout the receiver 104 These two features together allow the overall planter apparatus described herein to be carried by hands that lack the fine motor skills to adjust their grip and/or cannot apply great amounts of pressure (such as children and people with diminished hand strength/stability).

By way of example of the invention descried herein, an improved combined planter insert and an associated base apparatus is provided. In one particular implementation, a planter portion is configured to receive a planting medium and one plants for implantation into the planting material, the planter portion having a base, two opposing first sidewalls having a first length and two opposing second sidewalls having a second length, wherein the first and second side walls are joined to the base at an angle other than 90-degrees; the base portion and the first side walls having a plurality of passages therethrough, a rim connected to the first and second side walls by a shoulder; and a receiver portion configured to receive the planter portion, the receiver portion having a bottom portion configured with at least one depression disposed therein, a first opposing pair of receiver side walls and a second opposing pair of receiver side walls, the first and second receiver pairs each joined to the bottom portion, a receiver rim connected to the first and second receiver pairs, wherein the first receiver side walls have substantially the same length as the first opposing side walls of the planter portion and the second receiver sidewalls have a length that is greater than the second side walls of the planter portion; wherein upon receiving the planter portion in the receiver portion, the rim of the planter portion lays substantially atop the rim of the base portion and the base of the planter portion lays substantially atop the base of the receiver portion.

In a further implementation, an improved planter apparatus is provided, the improved planter apparatus including a planter portion, wherein the planter portion is configured to receive a planting medium and at least one plant for implantation into the planting medium, the planter portion having a base portion, two opposing first sidewalls having a first length and two opposing second sidewalls having a second length, wherein the first and second side walls are joined to the base at a base angle other than 90-degrees; the base portion and the first side walls having a plurality of passages therethrough, a planter rim connected to the first and second side walls and extending orthogonally thereto; and a receiver portion, where the receiver portion configured to receive the planter portion, the receiver portion having a bottom portion configured with at least one depression disposed therein, a first opposing pair of receiver side walls and a second opposing pair of receiver side walls, the first and second receiver pairs each joined to the bottom portion, a receiver rim connected to the first and second receiver pairs and extending orthogonally thereto; and wherein upon receiving the planter portion in the receiver portion, the planter rim lays substantially atop the receiver rim.

The improved planter apparatus of any of the previous implementations wherein the second receiver sidewalls of the receiver portion have a length that is greater than the second side walls of the planter portion.

The improved planter apparatus of any of the previous implementations wherein the first opposing pair of receiver side walls and a second opposing pair of receiver side walls are joined to the bottom portion at a receiver angle other than 90-degrees.

The improved planter apparatus of any of the previous implementations wherein the base angle is different than the receiver angle.

The improved planter apparatus of any of the previous implementations, wherein the base angle is equal to the receiver angle.

The improved planter apparatus of any of the previous implementations, wherein the first and second side walls are connected to the planter rim by a shoulder portion connected to a top portion of both the first and second side walls, wherein the planter shoulder portion includes a planter extension rim that extends horizontally from the top of the portion of both the first and second side walls and a planter extension wall that extends vertically form an end portion of the planter extension rim.

The improved planter apparatus of any of the previous implementations, wherein the extension rim is joined to the top portion of both the first and second side walls at an angle other than 90-degrees and the extension wall extends vertically from the end portion of the extension rim at an angle other that 90-degrees.

The improved planter apparatus of any of the previous implementations, wherein the side walls and a second opposing pair of receiver side walls are connected to the receiver rim by a receiver shoulder portion connected to a top portion of both first side walls and a second opposing pair of receiver side walls, wherein the receiver shoulder portion includes an receiver extension rim that extends horizontally from the top of a portion of the first side walls and a second opposing pair of receiver side walls and a receiver extension wall that extends vertically form an end portion of the receiver extension rim.

The improved planter apparatus of any of the previous implementations, wherein the receiver extension rim is joined to the top portion of first side walls and a second opposing pair of receiver side walls at an angle other than 90-degrees and the receiver extension wall extends vertically from the end portion of the receiver extension rim at an angle other that 90-degrees.

The improved planter of any of the previous implementations, wherein the at least one depression disposed therein includes a first elongate depression and a second elongate depression.

While this specification contains many specific embodiment details, these should not be construed as limitations on the scope of any embodiment or of what can be claimed, but rather as descriptions of features that can be specific to particular embodiments of particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described above should not be understood as requiring such separation in all embodiments, and it should be understood that the described program components and systems can generally be integrated together in a single software product or packaged into multiple software products.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

It should be noted that use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results.

Publications and references to known registered marks representing various systems maybe cited throughout this application, the disclosures of which are incorporated herein by reference. Citation of any above publications or documents is not intended as an admission that any of the foregoing is pertinent prior art, nor does it constitute any admission as to the contents or date of these publications or documents. All references cited herein are incorporated by reference in their respective entireties to the same extent as if each individual publication and references were specifically and individually indicated to be incorporated by reference.

While the invention has been particularly shown and described with reference to a preferred embodiment thereof, it will be understood by those skilled in the art that various changes in form and details may be made therein without departing from the spirit and scope of the invention. As such, the invention is not defined by the discussion that appears above, but rather is defined by the points that follow, the respective features recited in those points, and by equivalents of such features.

What is claimed is:

1. An improved planter apparatus comprising:
A planter portion, wherein the planter portion is configured to receive a planting medium and at least one plant for implantation into the planting medium, the planter portion having a base portion, two opposing first sidewalls having a first length and two opposing second sidewalls having a second length, wherein the first and second side walls are joined to the base at a base angle other than 90-degrees; the base portion and the first side walls having a plurality of passages therethrough, a planter rim connected to the first and second side walls and extending orthogonally thereto;
a receiver portion, where the receiver portion configured to receive the planter portion, the receiver portion having a bottom portion configured with at least one depression disposed therein, a first opposing pair of receiver side walls and a second opposing pair of receiver side walls, the first and second receiver pairs each joined to the bottom portion, a receiver rim connected to the first and second receiver pairs and extending orthogonally thereto; and
wherein upon receiving the planter portion in the receiver portion, the rim of the planter portion lays substantially atop the rim of the receiver portion and the base of the planter portion lays substantially atop the base of the receiver portion.

2. The improved planter apparatus of claim 1, wherein the second receiver sidewalls of the receiver portion have a length that is greater than the second side walls of the planter portion.

3. The improved planter apparatus of claim 1, wherein the first opposing pair of receiver side walls and a second opposing pair of receiver side walls are joined to the bottom portion at a receiver angle other than 90-degrees.

4. The improved planter apparatus of claim 1, wherein the base angle is different than the receiver angle.

5. The improved planter apparatus of claim 1, wherein the base angle is equal to the receiver angle.

6. The improved planter apparatus of claim 5, wherein the first and second side walls are connected to the planter rim by a shoulder portion connected to a top portion of both the first and second side walls, wherein the planter shoulder portion includes a planter extension rim that extends horizontally from the top of the portion of both the first and second side walls and a planter extension wall that extends vertically form an end portion of the planter extension rim.

7. The improved planter apparatus of claim 6, wherein the extension rim is joined to the top portion of both the first and second side walls at an angle other than 90-degrees and the extension wall extends vertically from the end portion of the extension rim at an angle other that 90-degrees.

8. The improved planter apparatus of claim 6, wherein the side walls and a second opposing pair of receiver side walls are connected to the receiver rim by a receiver shoulder portion connected to a top portion of both first side walls and a second opposing pair of receiver side walls, wherein the receiver shoulder portion includes an receiver extension rim that extends horizontally from the top of a portion of the first side walls and a second opposing pair of receiver side walls and a receiver extension wall that extends vertically form an end portion of the receiver extension rim.

9. The improved planter apparatus of claim 8, wherein the receiver extension rim is joined to the top portion of first side walls and a second opposing pair of receiver side walls at an angle other than 90-degrees and the receiver extension wall extends vertically from the end portion of the receiver extension rim at an angle other that 90-degrees.

10. The improved planter of claim 1, wherein the at least one depression disposed therein includes a first elongate depression and a second elongate depression.

11. The improved planter of claim 1, wherein the base of the planter portion lays substantially atop the bottom of the receiver portion when the planter portion is inserted into the receiver portion.
